(19) United States
(12) Patent Application Publication
(10) Pub. No.: US 2006/0175771 A1
(43) Pub. Date: Aug. 10, 2006

(54) Clamping insert for clamping jaws

(75) Inventor: Fritz Rehm, Oberteuringen (DE)

Correspondence Address: Pandiscio & Pandiscio, 470 Totten Pond Road, Waltham, MA, 02451, US

(73) Assignee: SMW-Autoblok Spannsysteme GmbH

(21) Appl. No.: 11/335,241

(22) Filed: Jan. 19, 2006

(30) Foreign Application Priority Data
Jan. 22, 2005 (DE) 10 2005 003 034.3

(51) Int. Cl. B23B 31/16

(52) U.S. Cl. 279/123

(57) ABSTRACT

In a clamping insert (11) for clamping jaws (4) comprising a base element (12) that can be inserted in a recess (6) worked into the clamping jaw (4) and that can be connected with a releasable connection, with clamping teeth (14) formed onto the clamping insert (11), the base element (12) is supported in the recess (6) so that it cannot rotate and has a contact surface on the end surface facing the workpiece (10) to be clamped that is provided with one or more clamping teeth (14), the contact surface being offset in relation to the clamping teeth (14) and formed as a stop (15).

By means of this embodiment, it is possible not only to make the clamping insert (11) easy to assemble and to achieve a long service life for the clamping teeth (14), but also above all to make the penetration depth of the clamping teeth (14) into the workpiece (10) predefined and adapted to the particular application.

The present invention relates to a clamping insert for the clamping jaws of clamping fixtures, in particular chucks, comprising a base element that can be inserted in a recess worked into the clamping jaw and can be connected to this in a releasable connection and onto which are formed one or more clamping teeth that project beyond the clamping surface and act on a workpiece.

Clamping claw inserts of this type are familiar from DE 38 10 854 C2. The base elements of these clamping claw inserts are formed as roller bodies in this case, with the result that they are mounted sliding about their longitudinal axis and can rotate in relation to the axis of rotation of the tool. In addition, only two clamping teeth are provided on the clamping insert, these being arranged with a lateral clearance from one another in the circumferential direction, with the result that a workpiece is only held in a chuck by the clamping teeth of the clamping inserts.

A disadvantage of this embodiment is that it is not possible to adjust the penetration depth of the clamping teeth into a workpiece to be clamped, rather the clamping teeth penetrate more or less far into the workpiece as a function of the force acting on the clamping jaws. If the penetration depth is insufficient, consequently, one effect may be that the workpiece is not held sufficiently strongly whereas, if the clamping force is too high on the other hand, the workpiece may undergo impermissible deformation or even suffer damage. Furthermore, the clamping teeth are subjected to high loads in many cases and are thereby exposed to high levels of wear. Satisfactory clamping of a workpiece is therefore frequently impossible to achieve using the clamping claw inserts of prior art.

The task of the present invention is therefore to produce a clamping insert for clamping jaws of the aforementioned kind that is not only easy to assemble and offers a long service life, but also in which the penetration depth of the clamping teeth into the workpiece is predefined and can be adapted to the particular application. Furthermore, manufacture of the clamping inserts and the corresponding recesses in the clamping jaw should be possible inexpensively while nevertheless the clamping inserts should offer high dimensional accuracy and permit positionally accurate clamping of a workpiece.

In accordance with the present invention, this is achieved in a clamping insert of the aforementioned kind in that the base element is supported in the recess of the clamping jaw so that it cannot rotate and that the base element has a contact surface on the end surface facing the workpiece to be clamped that is provided with one or more clamping teeth, the contact surface being set back in relation to the clamping teeth and formed as a stop.

The rotationally fixed support of the base element in the recess in the clamping jaw guarantees that the forces accepted by the clamping inserts are immediately transmitted by them to the clamping jaws and that the clamping teeth are always exactly aligned in relation to the workpiece. Furthermore, the stop provided on the clamping insert ensures that the clamping teeth only penetrate into the workpiece by a predefined, selectable depth up to contact with the stop, and therefore that deformation and damage to the workpiece are reliably avoided but that secure positive and non-positive clamping is guaranteed.

It is advantageous in this case for the base element of the clamping insert to have the shape of a block and for it to be inserted into a recess adapted to the block and worked into the clamping jaw.

In addition, the external surface of the base element facing the end surface provided with the stop should be formed by a cylindrical surface connecting the two lateral surfaces, and the two lateral surfaces and the cylindrical surface of the base element should taper continuously in the direction of the front end surface of the clamping insert, in which case the lateral surfaces and the cylindrical surface should taper at an angle of 10 to 20°, the preferred value being approx. 15°.

Furthermore, it is advantageous for the stop of the base element to be arranged starting from the front end surface of the clamping insert in front of the clamping teeth and for the stop to be formed by a stop bar running at a distance from the front end surface of the base element and perpendicular to the longitudinal axis of the clamping insert.

In order to pull the clamped workpiece in the direction of the clamping fixture, the clamping teeth should be formed with a trapezoidal or triangular cross section in the direction of the longitudinal axis of the base element, in which case the tooth surface of the clamping teeth facing towards the front end surface of the clamping insert should be running at an obtuse angle α and the end surface of the clamping teeth facing towards the rear contact surface of the clamping insert should be running at an acute angle β in relation to the stop and the inclination angles α and β of the tooth surfaces should be about 75° to 85° or between about 25° and 35° respectively.

In a different embodiment, the clamping teeth of the base element can also be formed by one or more continuous or interrupted toothed bars running with their axes in parallel to the longitudinal axis of the clamping insert, with in a preferred embodiment the clamping teeth comprising a toothed bar provided in the centre of the end surface of the clamping insert facing towards the workpiece to be clamped, or comprising two toothed bars arranged at a lateral distance from one another and with their axes running in parallel to the longitudinal axis of the clamping insert.

In order to enable a particularly high torque to be transferred, it is furthermore advantageous for the end surfaces of the clamping teeth facing towards the workpiece to be clamped to be formed with a wholly or partially convex curvature. Also, the end surface of the clamping insert facing towards the workpiece should be formed on one or both sides of a clamping tooth and/or between several clamping teeth as a contact surface with a convex curvature. When there are two clamping teeth provided at a lateral distance from one another on the end surface, it is appropriate for a contact surface with a convex curvature to be provided in between them as a stop.

In order to accommodate the material accumulations on a workpiece that are caused by the clamping teeth during clamping, a cavity should be provided between the clamping teeth and the stop bar or between the clamping teeth configured as toothed bars and the stop, this cavity running perpendicular or parallel to the longitudinal axis of the clamping insert, recessed in relation to the stop and, in a preferred embodiment, formed as a groove. Furthermore, the clamping teeth and the stop bar can be recessed by means of bevels machined into the base element.

It is advantageous for the clamping insert to be attached to the clamping jaw by means of a Torx bolt supported in a hole provided with a contact surface that has a truncated conical shape and engaging in a threaded hole worked into the clamping jaw.

In this embodiment, the longitudinal axis of the threaded hole provided in the clamping jaw should be offset slightly outwards in a radial direction in relation to the longitudinal axis of the hole of the clamping insert supported in the clamping jaw, so that the clamping insert contacts the mating surfaces of the clamping jaw with its lateral surfaces and above all with the cylindrical surface under a preload.

In order to set the jaw concentricity of a chuck, it is furthermore advantageous for the clamping jaw accommodating the clamping insert to be provided with an insert by means of which the clamping jaw is supported on a cotter provided on an assigned base jaw. The insert in this case can consist of a rail formed with a U-shaped cross section that is inserted in a recess worked onto the back of the clamping jaw facing the cotter and that is connected to the clamping jaw in an exchangeable connection by means of a clamping screw, so that imperfect concentricity can be compensated for by exchanging the insert.

In order to reduce the wear, the clamping insert should be provided with a friction-reducing coating, for example titanium nitrite, on at least the end surface facing towards the workpiece to be clamped, while furthermore the base element of the clamping insert should be made of a high-alloy hardened tool steel and the clamping teeth as well as the stop bar on the end surface facing towards the workpiece to be clamped should be machined out of one blank by means of electrical discharge machining.

If a clamping insert is manufactured in accordance with the present invention, it will be guaranteed that a workpiece can be clamped in a positive and non-positive arrangement by means of a clamping fixture that is equipped with clamping inserts of this type, without the danger of inadequate or excessive clamping force acting on the workpiece or of having to accept the risk of damage arising as a result. This is because the stop provided on the clamping inserts ensures that the clamping teeth only penetrate into the workpiece in accordance with the selected projection beyond the stop, and therefore ensure that the workpiece is only undergoes slight deformation. By pressing the clamping teeth into the workpiece, however, it is assured that the workpiece will be securely clamped at all times, even when the clamping force between the clamping jaws is low, and that it can be machined accordingly.

The depth of penetration of the clamping teeth can be selected using the stop in accordance with the workpiece that is to be machined, and therefore the depth of penetration is a known factor, so that the machining allowance of the workpiece can also be specified with the result that reworking of a workpiece only requires a minimum amount of work. Furthermore, the embodiment described in the present invention provides a high level of dimensional accuracy of the clamping inserts and a long service life, whilst above all the configuration of the clamping teeth as hooks in accordance with the present invention makes it possible to achieve a draw-down effect meaning that the penetration of the clamping teeth into the clamped workpiece causes it to be pulled in the direction of the clamping fixture. If, on the other hand, the clamping teeth are configured in the form of toothed bars with parallel axes, it is possible to transmit high torque values onto a workpiece in the circumferential direction.

In addition, the concentric accuracy of the clamping fixture can easily be corrected with the help of the insert without the need to hollow-turn the jaws. A clamping fixture equipped with clamping inserts embodied in accordance with the present invention therefore makes it possible to achieve an adequate clamping effect that is adapted to the particular workpiece to be machined irrespective of the magnitude of the clamping forces, so that the workpiece will not be damaged and the costs of machining the clamping insert and the corresponding recess in the clamping jaw will not be high.

The drawing shows a sample embodiment of a clamping insert configured in accordance with the present invention, the details of which are explained below. In the drawing,

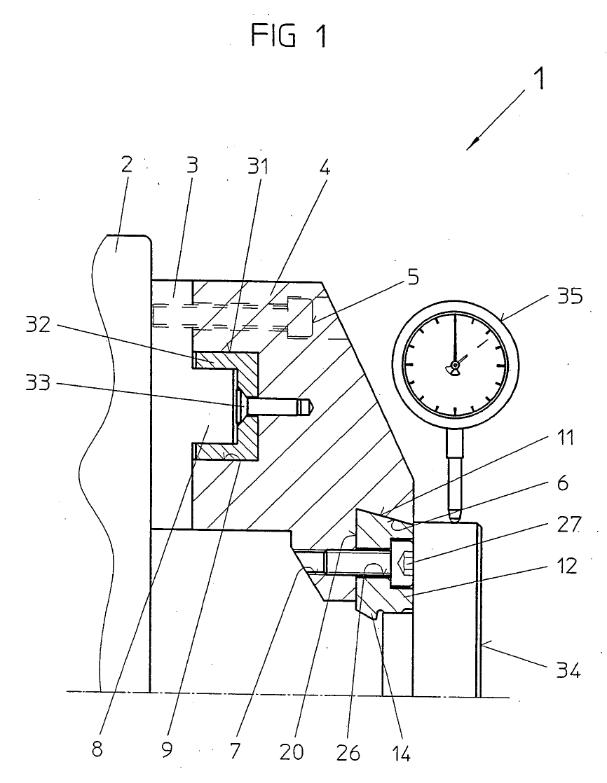

FIG. 1 shows a clamping fixture with a clamping insert inserted in its clamping jaws when setting the concentricity, in a partial axial section,

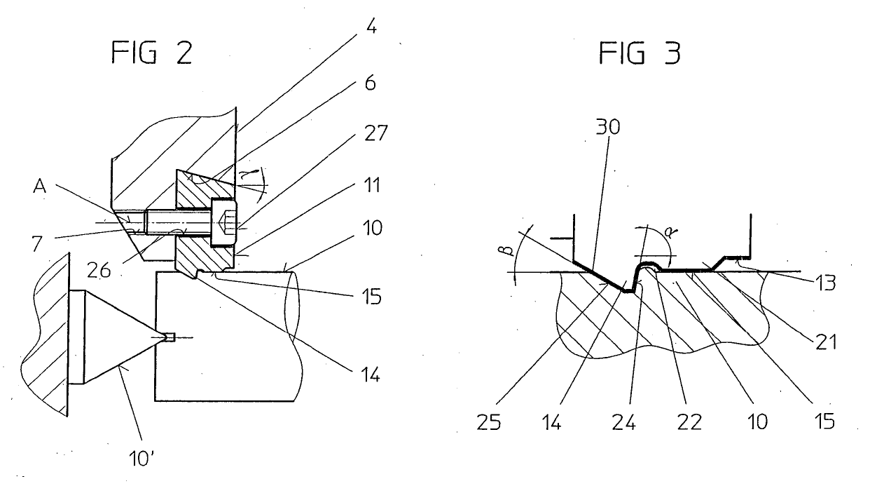

FIG. 2 shows the clamping jaw in accordance with FIG. 1 with a clamped workpiece, in a magnified view,

FIG. 3 shows a section from FIG. 2 in a further magnified view,

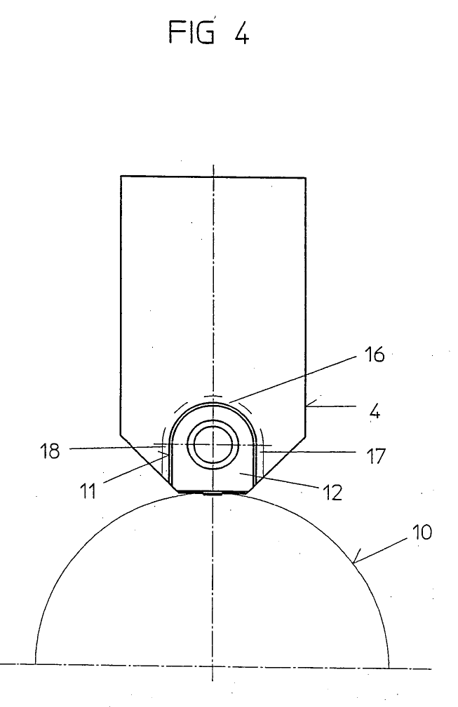

FIG. 4 shows the clamping jaw with clamping insert in accordance with FIG. 1, in a front view,

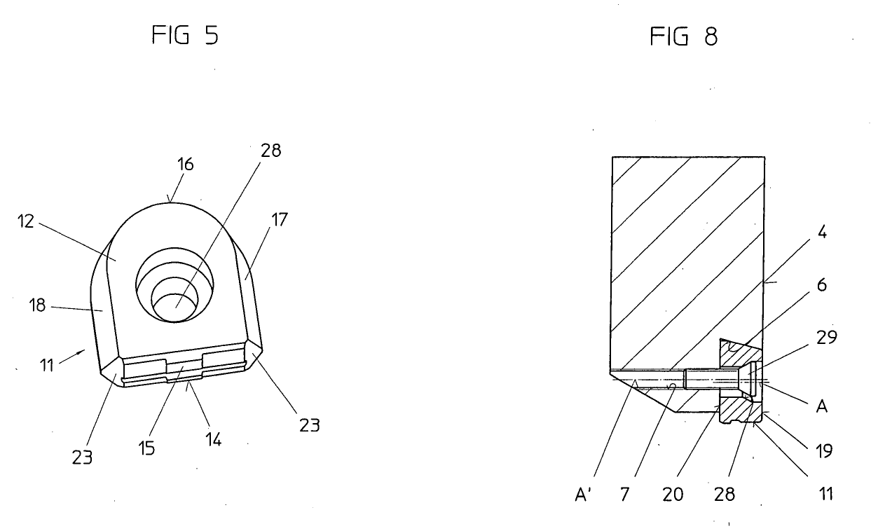

FIG. 5 shows the clamping insert inserted into the clamping jaw in accordance with FIG. 1, in a magnified isometric view,

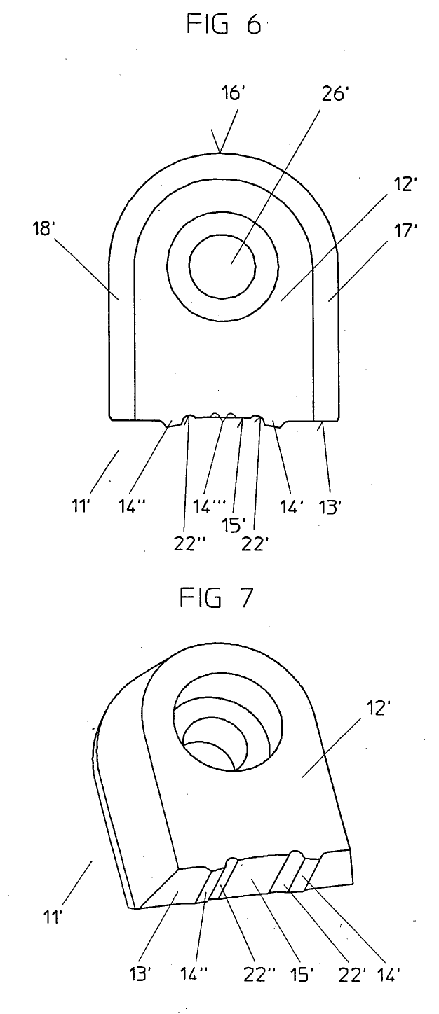

FIG. 6 shows a clamping insert with clamping teeth in running in line with its longitudinal axis, and a stop,

FIG. 7 shows the clamping insert in accordance with FIG. 6, in an isometric view, and

FIG. 8 shows a different method of attaching the clamping insert in the clamping jaw in accordance with FIG. 1.

The clamping fixture shown in FIG. 1 and identified with 1 is used for clamping workpieces by means of a chuck 2, the radially adjustable clamping jaws 4 of which act on the workpiece to be clamped. The clamping jaws 4 are each attached to a base jaw 3 by bolts 5 in this case, the base jaws 3 being arranged in a chuck body in a radially adjustable manner.

In order to hold a workpiece 10 in a positive and non-positive way, as shown in FIGS. 3 and 4—where the workpiece 10 is clamped between tips 10′—a clamping insert 11 is inserted in a recess 6 in each clamping jaw 4, the clamping insert 11 being attached to the clamping jaw 4 in an exchangeable way by means of a cylinder head screw 27 engaging in a threaded hole 7. In this case, the longitudinal axis of the threaded hole 7 symbolizes the longitudinal axis A of the clamping insert 11. The cylinder head screw 27 passes through a stepped hold 26 worked into the clamping insert 11 and is supported against it, with the result that the clamping insert 11 is pressed against the clamping jaw 4 with its rear contact surface 20.

The clamping insert 11 consists of a block-shaped base element 12 with a clamping tooth 14 running perpendicular to the longitudinal axis A as well as a stop 15 worked into the end surface 13 of the base element 12 that faces towards the tool 10. The surface of the base element 12 opposite to this is formed as a cylindrical surface 16, whereas the two lateral surfaces 17 and 18 of the base element 12 are flat.

The cylindrical surface 16 as well as the two lateral surfaces 17 and 18 of the base element 12 are at an angle of 15° in relation to the longitudinal axis A of the clamping insert 11, and the mating surfaces of the recess 6 incorporating the clamping insert 11 are formed in the same way. This counteracts any bending open of the clamping insert 12.

In the embodiment illustrated, the clamping teeth 14 have a trapezoidal cross section, with the result that the tooth surfaces 24 and 25 of the clamping tooth 14 run at an angle α or β in relation to the stop 15. The obtuse angle α in the embodiment illustrated is 85°, whereas the acute angle β is only about 15°. When the clamping tooth 14 is pressed into the workpiece 10, the clamping insert 11 is thereby pressed towards the chuck 2 by means of the deflection force, with the effect that the resulting draw-down counteracts any unwanted opening of the clamping jaw 4.

The material displaced when the clamping tooth 14 is pressed into the tool 10 is accommodated in a cavity 22 worked into the base element 12 in between the clamping tooth 14 and the stop 15. The displaced material therefore does not cause any distortion of the workpiece 10 and/or the clamping jaw 4, particularly since the stop 15, as seen from the front end surface 19 of the clamping insert 11, is formed as a stop bar 21 running in front of the clamping tooth 14 perpendicular to the longitudinal axis A and a bevel 23 is worked onto each of the lateral surface 17 and 18.

The clamping insert 11 is in a positive connection with the workpiece 10 by means of the clamping tooth 14, as shown in FIG. 3, and it is in a non-positive connection with the workpiece 10 by means of the stop 15, which means that a satisfactory engagement is guaranteed at all times. Because the stop 15 lies flat on the tool 10, the clamping tooth 14 can only penetrate into the workpiece 10 as far as the projection beyond the stop 15—even when a high level of force is applied—and therefore the workpiece 10 is not significantly deformed by the clamping tooth 14. And because the amount of the projection and therefore the depth of penetration can be selected, this means it is easy to adapt to the various workpieces to be clamped by exchanging the clamping inserts 11.

The clamping insert 11′ shown in FIGS. 6 and 7 is equipped with two clamping teeth 14′ and 14″ arranged with a lateral clearance from one another on its surface 13′ facing towards the workpiece to be clamped, with the clamping teeth 14′ and 14″ arranged with their axes in parallel with the longitudinal axis (A) of the clamping insert 11′ and formed as toothed bars. The stop 15′ is arranged in between the clamping teeth 14′ and 14″ and is set back in relation to them. As shown by the thinner lines in FIG. 6, the clamping insert 11′ can alternatively also only have one clamping tooth 14′″ worked onto the middle of the base element 12′.

The surfaces of the clamping teeth 14′ and 14″ facing towards the workpiece to be clamped as well as the surfaces of the stop 15′ have a convex curvature, with the result that there is a large contact surface for the workpiece in each case. In contrast, the external parts of the end surface 13′ are flat. The configuration of the clamping insert 11′ is particularly suitable for transmitting high torque values because there are large contact surfaces both on the clamping teeth 14′, 14″ as well as on the stop 15′.

The two lateral surfaces 17′ and 18′ of the base element 12′ as well as its cylindrical surface 16′ and the hole 26′ worked into it are configured in the same way as clamping insert 11. In addition, cavities 22′ and 22″ in the form of grooves are provided in between the clamping teeth 14′, 14″ and the stop 15′, which also run in the direction of the longitudinal axis A of the clamping insert 11′.

In accordance with the embodiment shown in FIG. 8, the clamping insert 11 is attached to the clamping jaw 4 by means of a Torx bolt 29 that is supported in a passage hole 28 provided with a contact surface that has a truncated conical surface and is screwed into the threaded hole 7. Furthermore, the longitudinal axis A′ of the threaded hole 7 is offset slightly outwards in a radial direction in relation to the longitudinal axis A of the hole 28. In this way, the clamping insert 11 is firmly pressed against the clamping jaw 11, in particular with the cylindrical surface 16, so that a zero-play contact is assured.

In order to enable the concentricity of the clamping jaws 4 of the chuck 2 to be adjusted, as can be seen in FIG. 1, a cotter 8 is formed onto each of the base jaws 3, and an insert 31 formed as a U-shaped rail 32 is inserted in a recess 9 worked into the clamping jaw 4, with the insert 31 being connected to the clamping jaw 4 by means of a screw 33 in an exchangeable connection. Using a master cylinder 34 that is to be clamped in the clamping inserts 11 and a dial gauge 35, it is possible to measure deviations in the concentricity, while any possible imbalance can be compensated for by exchanging the clamping inserts 31 that have legs with different thickness values.

The base element 12 of the clamping insert 11 consists of a high-alloy hardened tool steel and is produced from one blank, from which the stop bar 15 as well as the cavity 22 are machined on the end surface 13 of the clamping tooth 14, by means of electrical discharge machining. In addition, at least the end surface 13 with the clamping tooth 14, the stop bar 15 and the cavity 22 are provided with a friction-reducing coating 30.

1. A clamping insert (11, 11′) for clamping jaws (4) of clamping fixtures (1), in particular chucks (2), comprising a base element (12, 12′) insertable into a recess (6) in the clamping jaw (4) and releasably connectable to said base element, and at least one clamping tooth formed on said base element, said tooth projecting beyond a clamping surface and engageable with a work piece (10),
wherein
said base element (12, 12′) is supported in the recess (6) of the clamping jaw (4) so that it cannot rotate and said base element (12, 12′) is provided with a contact surface on an end surface (13, 13′) thereof facing the workpiece (10) to be clamped, the end surface being provided with said clamping tooth, the contact surface being set back in relation to the clamping tooth and formed as a stop (15, 15′).

2. The clamping insert in accordance with claim 1,
wherein
said base element (12, 12′) of the clamping insert (11, 11′) is provided with a shape of a block and is insertable into the recess (6) adapted to receive the block and disposed in the clamping jaw (4).

3. The clamping insert in accordance with claim 2,
wherein
an external surface of said base element (12, 12′) opposite the end surface (13, 13′) provided with the stop (15, 15′) is formed by a cylindrical surface (16, 16′) connecting two lateral surfaces (17, 18 or 17′, 18′).

4. The clamping insert in accordance with claim 3,
wherein
the two lateral surfaces (17, 18 or 17′, 18′) and the cylindrical surface (16, 16′) of said base element (12, 12′) taper continuously in the direction of a front end surface (19) of the clamping insert (11, 11′).

5. The clamping insert in accordance with claim 4,
wherein
the lateral surfaces (17, 18 or 17′, 18′) and the cylindrical surface (16, 16′) of the base element (12, 12′) taper at an angle of 10 to 20°.

6. The clamping insert in accordance with claim 4, wherein
the stop (15) of said base element (12) is arranged starting from the front end surface (19) of the clamping insert (11) in front of said clamping tooth (14).

7. The clamping insert in accordance with claim 6,
wherein
the stop (15) of said base element (12) is formed by a stop bar (21) running from the front end surface (19) of said base element (12) and perpendicular to a longitudinal axis of the clamping insert (11).

8. The clamping insert in accordance with
claim 7, wherein
said clamping tooth (14) is formed with a selected one of a trapezoidal and triangular cross section in the direction of the longitudinal axis of said base element (12).

9. The clamping insert in accordance with claim 8,
wherein
a tooth surface (24) of said clamping tooth (14) facing towards the front end surface (19) of the clamping insert (11) runs at an obtuse angle and an end surface (25) of said clamping tooth (14) facing towards a rear contact surface (20) of the clamping insert (11) runs at an acute angle in relation to the stop (15).

10. The clamping insert in accordance with claim 9,
wherein
the inclination angles of the tooth surfaces (24, 25) are about 75° to 85° and about 25° to 35° respectively.

11. The clamping insert in accordance with
claim 7, wherein the insert comprises a further clamping tooth, and said clamping teeth (14′, 14″ or 14′″) of said base element (12′) are each formed by at least one toothed bars running with each clamping tooth axis in parallel to the longitudinal axis of the clamping insert (11′).

12. The clamping insert in accordance with claim 11,
wherein
said clamping teeth (14′″) of said base element (12′) are formed by a toothed bar provided in the centre of the end surface (13′) of the clamping insert (11′) facing towards the workpiece to be clamped.

13. The clamping insert in accordance with claim 11,
wherein
said clamping teeth (14′″) of the base element (12′) are formed by two toothed bars arranged at a lateral distance from one another and with their axes running in parallel to the longitudinal axis of the clamping insert (11′).

14. The clamping insert in accordance with
claim 12, wherein
the end surfaces of said clamping teeth (14, 14′ or 14″) facing towards the workpiece to be clamped are formed with a convex curvature.

15. The clamping insert in accordance with
claim 14, wherein
the end surface (13′) of the clamping insert (11′) facing towards the workpiece is formed on at least one side of said clamping teeth (14′, 14″ or 14″) and/or between said clamping teeth (14′, 14″ or 14″) as a contact surface with a convex curvature.

16. The clamping insert in accordance with claim 15,
wherein
when there are two clamping teeth (14′, 14″) provided at a lateral distance from one another on the end surface (13′) of the clamping insert (11′), a contact surface with a convex curvature is provided in between said clamping teeth as a stop (15).

17. The clamping insert in accordance with
claims 11, wherein
a cavity (22 or 22′, 22″) is provided selectively between said clamping teeth (14) and a stop bar (21) and between the clamping teeth (14′, 14″) configured as toothed bars and the stop (15′), the cavity (22 or 22′, 22″) running a selected one of perpendicular and parallel to the longitudinal axis of the clamping insert (11), recessed in relation to the stop (15, 15′) and formed as a groove.

18. The clamping insert in accordance with claim 7,
wherein
the clamping teeth (14) and the stop bar (21) running perpendicular to the axial direction of the clamping insert (11) are recessed by means of bevels (23) machined into said base element (12).

19. The clamping insert in accordance with claim 1,
wherein
the clamping insert (11) is attached to the clamping jaw (4) by means of a bolt (29) supported in a hole (28) provided with a contact surface that has a truncated conical shape and engaging in a threaded hole (7) in the clamping jaw (4).

20. The clamping insert in accordance with claim 19,
wherein
the longitudinal axis of the threaded hole (7) provided in the clamping jaw (4) is offset outwards in a radial direction in relation to the longitudinal axis of the hole (28) of the clamping insert (11) supported in the clamping jaw (4).

21. The clamping insert in accordance with
claim 1, wherein
in order to set the jaw concentricity, the clamping jaw (4) of a chuck (2) accommodating the clamping insert (11) is provided with an insert (31) by means of which the clamping jaw (4) is supported on a cotter (8) provided on a base element (3).

22. The clamping insert in accordance with claim 21,
wherein
the insert (31) comprises a rail (32) formed with a U-shaped cross section that is inserted in a recess (9) in the back of the clamping jaw (4) facing away from the cotter (8) and is connected to the clamping jaw (4) by a releasable connection by means of a clamping screw (33).

23. The clamping insert in accordance with claim 1,
wherein
the clamping insert (11) is provided with a friction-reducing coating (30), f on at least the end surface (13) facing towards the workpiece (10) to be clamped.

24. The clamping insert in accordance with
claim 17, wherein
said base element (12) of the clamping insert (11) is made of a high-alloy hardened tool steel, and said clamping teeth (14) and the stop bar (21) and the cavity (22) on the end surface (13) facing towards the workpiece (10) to be clamped are machined out of one blank by means of electrical discharge machining.
